(19) United States
(12) Patent Application Publication
(10) Pub. No.: US 2023/0289694 A1
(43) Pub. Date: Sep. 14, 2023

(54) AUTOMATIC PROVISIONING OF RECOMMENDATIONS FOR PROCESS OPTIMIZATION FOR ACHIEVING ORGANIZATIONAL STANDARDS

(71) Applicant: UiPath, Inc., New York, NY (US)

(72) Inventors: Palak KADAKIA, Redmond, WA (US); Matthew VANDERZEE, Sammamish, WA (US)

(73) Assignee: UiPath, Inc., New York, NY (US)

(21) Appl. No.: 17/654,791

(22) Filed: Mar. 14, 2022

(51) Int. Cl. G06Q 10/06; G06N 5/02; G06N 5/04

(52) U.S. Cl. CPC G06Q 10/06375; G06N 5/02; G06N 5/04

(57) ABSTRACT

Systems and methods for automatically provisioning recommendations for optimizing a process are provided. A knowledge graph for an organization is generated. The knowledge graph for the organization is compared with an optimized knowledge graph. Recommendations for optimizing a process of the organization are generated based on the comparing. The recommendations for optimizing the process are output.

### TECHNICAL FIELD

The present invention relates generally to automatic provisioning of recommendations for process optimization, and more particularly to automatic provisioning of recommendations for process optimization for achieving organizational standards.

### BACKGROUND

Organizations typically implement processes to automate repetitive tasks. Often times, the configuration of various systems, users, data models, processes, and robots within an organization needs to be updated or changed for optimizing the processes to achieve organization standards. Currently, a consultant or other user evaluates the configuration of the systems, users, data models, processes, and robots of the organization to manually recommend updates or changes. However, such manual recommendation of updates or changes is a labor-intensive and expensive process.

### BRIEF SUMMARY OF THE INVENTION

In accordance with one or more embodiments, systems and methods for automatically provisioning recommendations for optimizing a process are provided. A knowledge graph for an organization is generated. The knowledge graph for the organization is compared with an optimized knowledge graph. Recommendations for optimizing a process of the organization are generated based on the comparing. The recommendations for optimizing the process are output. The process may be an RPA (robotic process automation) process.

In one embodiment, the knowledge graph for the organization is compared with the optimized knowledge graph by determining a deviation of the knowledge graph for the organization from the optimized knowledge graph. A visualization showcasing the deviation is provided.

In one embodiment, the recommendations for optimizing the process are generated that would result in the knowledge graph of the organization approximating the optimized knowledge graph. The recommendations may comprise at least one of commissioning robots, optimizing data models, optimizing processes, optimizing user activities, or optimizing third-party systems. In one embodiment, the recommendations comprise commissioning robots to implement a process to achieve a better return on investment. In another embodiment, the recommendations comprise a defining an optimized data model for the organization.

In accordance with one or more embodiments, systems and methods for automatically provisioning recommendations for optimizing a process are provided. Requirements for an organization are received. A template comprising recommendations for optimizing a process of the organization is selected based on the requirements. The template is output. The output may be the template of an RPA process or an automation.

In one embodiment, user input defining the requirements is received from a user in response to a prompt to the user. The recommendations may relate to at least one of utilization of robots, utilization of processes, user activities, or third-party systems.

These and other advantages of the invention will be apparent to those of ordinary skill in the art by reference to the following detailed description and the accompanying drawings.

### BRIEF DESCRIPTION OF THE DRAWINGS

FIG. 1 shows a method for automatically provisioning recommendations for optimizing a process of an organization based on a knowledge graph of the organization, in accordance with one or more embodiments;

FIG. 2 shows a method for automatically provisioning recommendations for optimizing a process of an organization based on a template; and

FIG. 3 is a block diagram of a computing system according to an embodiment of the invention.

### DETAILED DESCRIPTION

Embodiments described herein provide for automatically provisioning recommendations for process optimization for achieving organizational standards. In one example, the process comprises an automation process, such as, e.g., an RPA (robotic process automation) process. RPA is a form of process automation that uses RPA software robots to automate processes. In accordance with one embodiment, recommendations for optimizing the process are provisioned by comparing a knowledge graph of an organization with an optimized knowledge graph. In accordance with another embodiment, a template comprising recommendations for optimizing the process is selected based on user defined requirements of the organization. Advantageously, embodiments described herein provide for the automatic provisioning of recommendations to optimize processes with minimal user input.

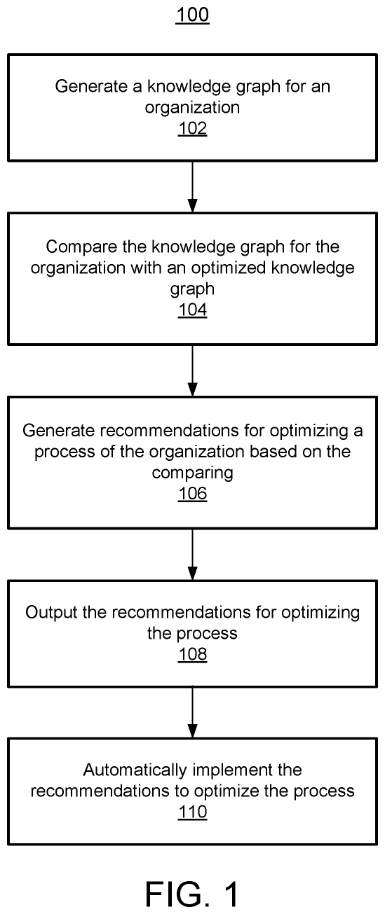

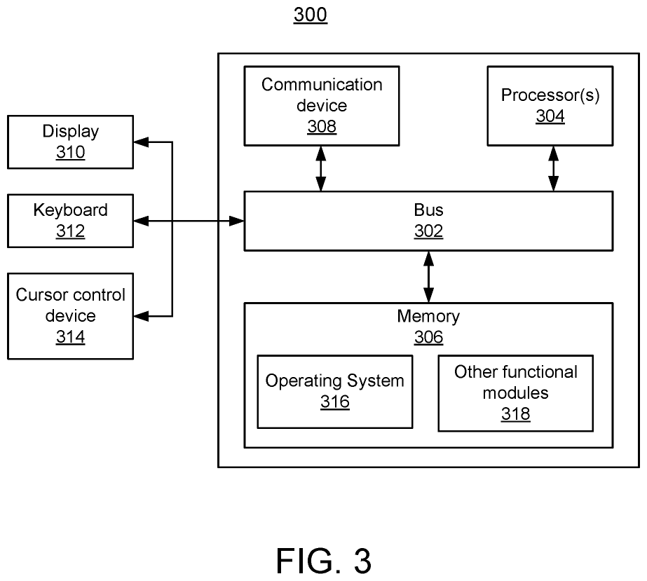

FIG. 1 shows a method 100 for automatically provisioning recommendations for optimizing a process of an organization based on a knowledge graph of the organization, in accordance with one or more embodiments. The steps of method 100 may be performed by any suitable computing device, such as, e.g., computing system 300 of FIG. 3.

At step 102, a knowledge graph for an organization is generated. As used herein, a knowledge graph is a graph-structured data model for integrating and interrelating data such as, e.g., processes, systems, individuals, entities, etc. of the organization. The knowledge graph may be generated according to any suitable approach. In one embodiment, the knowledge graph may be generated as described in U.S. patent application Ser. No. 17/654,785, filed Mar. 14, 2022, the disclosure of which is incorporated herein by reference in its entirety.

At step 104, the knowledge graph of the organization is compared with an optimized knowledge graph. The optimized knowledge graph represents relationships between, e.g., processes, systems, individuals, entities, etc. of a typical organization. The optimized knowledge graph may be generated by generating a knowledge graph for each of a plurality of organizations and combining the knowledge graphs for the plurality of organizations to generate the optimized knowledge graph.

The optimized knowledge graph could be formed in various ways. In one example, the optimized knowledge graph is generated by mean averaging the knowledge graphs for the plurality of organizations. The most common nodes and edges among the knowledge graphs are identified to generate an average or standardized graph. Mathematically, each node and edge is denoted as n1 . . . nN and (n1, n2, w) respectively. The most common nodes and edges are mean averaged to generate the optimized knowledge graph. In another embodiment, the optimized knowledge graph is generated by applying clustering algorithms to identify typical steps in a standardized process. Algorithms that compute the optimized knowledge graph may factor in any or all of the data in any of the knowledge graphs: step names, edge frequency, business system data, business metadata, etc. In another embodiment, the optimized knowledge graph may be defined at least in part by a user (e.g., an expert, a consultant, a team leader, etc.). For example, the user can modify an existing knowledge graph to generate the optimized knowledge graph.

The knowledge graph of the organization is compared with the optimized knowledge graph to benchmark the knowledge graph of the organization to the optimized knowledge graph and determine a deviation or variance of the knowledge graph of the organization from the optimized knowledge graph. When the knowledge graph of the organization and optimized knowledge graph are compared, the differences between the knowledge graph of the organization and optimized knowledge graph are analyzed. Those differences might be interpreted as single-node differences, for example a single step of the process has an alternative option that would improve the process operation. Alternately, there may be whole sections of the knowledge graph of the organization that might be replaced by a new subgraph. These two subgraphs can be compared to understand how to get from the subgraph of the knowledge graph of the organization to the subgraph of the optimized knowledge graph. In some cases, it is a simple rearrangement of the nodes, as in do Step B before Step A. In other cases, there may be differences only in the metadata for a step, as in there may be a new sequence of activities that will yield better outcomes than the current. In still other cases, the differences might be the absence/presence of automation—whole subgraphs may be replaced by a single automated step.

At step 106, recommendations for optimizing a process of the organization are generated based on the comparing. In one embodiment, the process is an automation process of an automation system, such as, e.g., an RPA system for automatically performing RPA workflows using one or more RPA robots. In other embodiments, the process is a technology process to generate recommendations for technology changes, a user process to generate recommendations for user optimization, data model processes to generate recommendations for data model changes, or any other suitable process. The recommendations for optimizing the process are recommendations that would result in the knowledge graph of the organization more closely aligning with the optimized knowledge graph. In one embodiment, the recommendations for optimizing the process are recommendations that would result in the knowledge graph of the organization approximating the optimized knowledge graph. In this manner, the recommendations optimize the process. In one embodiment, the recommendations are generated based on the differences between the knowledge graph of the organization and the optimized knowledge graph (determined by the comparison performed at step 104). These differences might be differences in graph nodes and connectivity, or differences in metadata and properties of the nodes in the graph. In the case that a subgraph can be replaced by an automation-driven subgraph, the recommendation can take the form of implementing RPA robots to execute the new subgraph. In another embodiment, the recommendations are generated based on user evaluations of the differences between the knowledge graph of the organization and the optimized knowledge graph.

The recommendations for optimizing the process may comprise any recommendation relating to the process. Exemplary recommendations include commissioning robots (e.g., RPA robots), optimizing data models, optimizing processes, optimizing user activities, optimizing third-party systems, or any other recommendation relating to the functioning of systems, users, data models, processes, robots, etc. of the organization. In one example, the recommendations may comprise commissioning robots to implement a specific process of the organization to achieve a better return on investment. In this example, the robots may be RPA robots implemented to perform an RPA workflow. In another example, the recommendations are formulated into configuration changes to existing RPA robots to improve how those robots operate (i.e., the RPA robots are automatically reconfigured). In a further example, the recommendations may comprise defining an optimized data model for the organization (e.g., to an SAP (systems, applications, and products) data model). In a further example, the recommendations may comprise defining steps of a user activity for performing a task.

At step 108, the recommendations for optimizing the process are output. For example, the recommendations for optimizing the process may be output by displaying the recommendations on a display device of a computer system, storing the recommendations on a memory or storage of a computer system, or by transmitting the recommendations to a remote computer system. At step 110, optionally, the recommendations are automatically implemented to optimize the process. For example, where the recommendations are recommendations for optimizing an RPA process of an RPA automation system, an RPA library can be queried to identify a preexisting robot that provides an execution graph that matches the subgraph of the optimized knowledge graph for the recommendation. If there is not a good match in the RPA library, a robot template or a set of documentation that informs the RPA developer as to how to proceed in implementing the recommendations is generated. In another example, where the recommendations are recommendations for optimizing a manual (user) process, documentation informing the users involved how to tune or adjust their processes is generated.

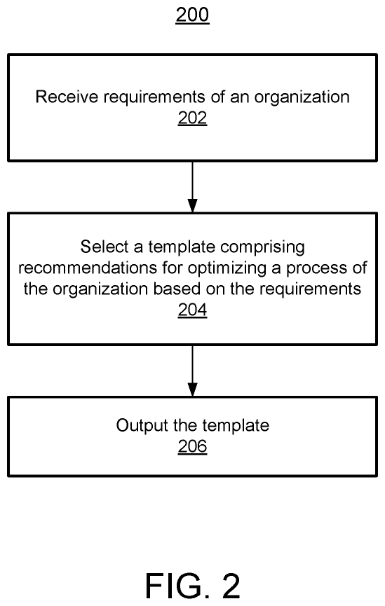

FIG. 2 shows a method 200 for automatically provisioning recommendations for optimizing a process of an organization based on a template, in accordance with one or more embodiments. The steps of method 200 may be performed by any suitable computing device, such as, e.g., computing system 300 of FIG. 3.

At step 202, requirements of an organization are received. In one embodiment, the process is an automation process of automation system, such as, e.g., RPA system for automatically performing RPA workflows using one or more RPA robots. In other embodiments, the process is a technology process to generate recommendations for technology changes, a user process to generate recommendations for user optimization, data model processes to generate recommendations for data model changes, or any other suitable process.

In one embodiment, the requirements of the organization are received from a user as user input. The user input may be received in response to a prompt. For example, the user may be prompted with the question “what system are you looking for” or “what specific industry does the organization relate to.”

At step 204, a template comprising recommendations for optimizing a process of the organization is selected based on the requirements. The template is a blueprint for starting a new process. The recommendations may comprise any recommendation relating to the process. For example, the recommendations may relate to the utilization of robots (e.g., RPA robots), the utilization of processes, automations, user activities, third-party systems, or any other recommendation relating to the functioning of systems, users, data models, processes, robots, etc. of the organization. In one embodiment, the recommendations represent actions performed by a typical organization.

At step 206, the template is output. For example, the template may be output by displaying the template on a display device of a computer system, storing the template on a memory or storage of a computer system, or by transmitting the template to a remote computer system. In one embodiment, the recommendations of the template may be automatically implemented.

In one embodiment, once the organization has implemented the recommendations in the template, a comparable view of insights may be presented via a display device visualizing the extent that the organization has reached its organizational standards before and after implementing the recommendations. The comparable view of insights may be presented as process maps or knowledge graphs. The process of the organization may be determined through process mining, task mining, and other inputs as described previously.

FIG. 3 is a block diagram illustrating a computing system 300 configured to execute the methods, workflows, and processes described herein, including method 100 of FIG. 1 and method 200 of FIG. 2, according to an embodiment of the present invention. In some embodiments, computing system 300 may be one or more of the computing systems depicted and/or described herein. Computing system 300 includes a bus 302 or other communication mechanism for communicating information, and processor(s) 304 coupled to bus 302 for processing information. Processor(s) 304 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 304 may also have multiple processing cores, and at least some of the cores may be configured to perform specific functions. Multi-parallel processing may be used in some embodiments.

Computing system 300 further includes a memory 306 for storing information and instructions to be executed by processor(s) 304. Memory 306 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 304 and may include volatile media, non-volatile media, or both. The media may also be removable, non-removable, or both.

Additionally, computing system 300 includes a communication device 308, such as a transceiver, to provide access to a communications network via a wireless and/or wired connection according to any currently existing or future-implemented communications standard and/or protocol.

Processor(s) 304 are further coupled via bus 302 to a display 310 that is suitable for displaying information to a user. Display 310 may also be configured as a touch display and/or any suitable haptic I/O (input/output) device.

A keyboard 312 and a cursor control device 314, such as a computer mouse, a touchpad, etc., are further coupled to bus 302 to enable a user to interface with computing system. However, in certain embodiments, a physical keyboard and mouse may not be present, and the user may interact with the device solely through display 310 and/or a touchpad (not shown). Any type and combination of input devices may be used as a matter of design choice. In certain embodiments, no physical input device and/or display is present. For instance, the user may interact with computing system 300 remotely via another computing system in communication therewith, or computing system 300 may operate autonomously.

Memory 306 stores software modules that provide functionality when executed by processor(s) 304. The modules include an operating system 316 for computing system 300 and one or more additional functional modules 318 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer-implemented method comprising:
generating a knowledge graph for an organization;
comparing the knowledge graph for the organization with an optimized knowledge graph;
generating recommendations for optimizing a process of the organization based on the comparing; and
outputting the recommendations for optimizing the process.

2. The computer-implemented method of claim 1, wherein comparing the knowledge graph for the organization with an optimized knowledge graph comprises:
determining a deviation of the knowledge graph for the organization from the optimized knowledge graph.

3. The computer-implemented method of claim 1, wherein generating recommendations for optimizing a process of the organization based on the comparing comprises:
generating the recommendations that would result in the knowledge graph of the organization approximating the optimized knowledge graph.

4. The computer-implemented method of claim 1, wherein the recommendations comprise at least one of commissioning robots, optimizing data models, optimizing processes, optimizing user activities, or optimizing third-party systems.

5. The computer-implemented method of claim 1, wherein the recommendations comprise commissioning robots to implement the process to achieve a better return on investment.

6. The computer-implemented method of claim 1, wherein the recommendations comprise defining an optimized data model for the organization.

7. The computer-implemented method of claim 1, wherein the process is an RPA (robotic process automation) process.

8. An apparatus comprising:
a memory storing computer instructions; and
at least one processor configured to execute the computer instructions, the computer instructions configured to cause the at least one processor to perform operations of:
generating a knowledge graph for an organization;
comparing the knowledge graph for the organization with an optimized knowledge graph;
generating recommendations for optimizing a process of the organization based on the comparing; and
outputting the recommendations for optimizing the process.

9. The apparatus of claim 8, wherein comparing the knowledge graph for the organization with an optimized knowledge graph comprises:
determining a deviation of the knowledge graph for the organization from the optimized knowledge graph.

10. The apparatus of claim 8, wherein generating recommendations for optimizing a process of the organization based on the comparing comprises:
generating the recommendations that would result in the knowledge graph of the organization approximating the optimized knowledge graph.

11. The apparatus of claim 8, wherein the recommendations comprise at least one of commissioning robots, optimizing data models, optimizing processes, optimizing user activities, or optimizing third-party systems.

12. The apparatus of claim 8, wherein the recommendations comprise commissioning robots to implement the process to achieve a better return on investment.

13. The apparatus of claim 8, wherein the recommendations comprise defining an optimized data model for the organization.

14. The apparatus of claim 8, wherein the process is an RPA (robotic process automation) process.

15. A non-transitory computer-readable medium storing computer program instructions, the computer program instructions, when executed on at least one processor, cause the at least one processor to perform operations comprising:
generating a knowledge graph for an organization;
comparing the knowledge graph for the organization with an optimized knowledge graph;
generating recommendations for optimizing a process of the organization based on the comparing; and
outputting the recommendations for optimizing the process.

16. The non-transitory computer-readable medium of claim 15, wherein comparing the knowledge graph for the organization with an optimized knowledge graph comprises:
determining a deviation of the knowledge graph for the organization from the optimized knowledge graph.

17. The non-transitory computer-readable medium of claim 15, wherein generating recommendations for optimizing a process of the organization based on the comparing comprises:
generating the recommendations that would result in the knowledge graph of the organization approximating the optimized knowledge graph.

18. The non-transitory computer-readable medium of claim 15, wherein the recommendations comprise at least one of commissioning robots, optimizing data models, optimizing processes, optimizing user activities, or optimizing third-party systems.

19. The non-transitory computer-readable medium of claim 15, wherein the recommendations comprise commissioning robots to implement the process to achieve a better return on investment.

20. The non-transitory computer-readable medium of claim 15, wherein the recommendations comprise defining an optimized data model for the organization.

21. The non-transitory computer-readable medium of claim 15, wherein the process is an RPA (robotic process automation) process.

22. A computer-implemented method comprising:
receiving requirements of an organization;
selecting a template comprising recommendations for optimizing a process of the organization based on the requirements; and
outputting the template.

23. The computer-implemented method of claim 22, wherein receiving requirements of an organization comprises:
receiving user input defining the requirements from a user in response to a prompt to the user.

24. The computer-implemented method of claim 22, wherein the recommendations relate to at least one of utilization of robots, utilization of processes, user activities, or third-party systems.

25. The computer-implemented method of claim 22, wherein the process is an RPA (robotic process automation) process.

26. An apparatus comprising:
a memory storing computer instructions; and
at least one processor configured to execute the computer instructions, the computer instructions configured to cause the at least one processor to perform operations of:
receiving requirements of an organization;
selecting a template comprising recommendations for optimizing a process of the organization based on the requirements; and
outputting the template.

27. The apparatus of claim 26, wherein receiving requirements of an organization comprises:
receiving user input defining the requirements from a user in response to a prompt to the user.

28. The apparatus of claim 26, wherein the recommendations relate to at least one of utilization of robots, utilization of processes, user activities, or third-party systems.

29. The apparatus of claim 26, wherein the process is an RPA (robotic process automation) process.

30. A non-transitory computer-readable medium storing computer program instructions, the computer program instructions, when executed on at least one processor, cause the at least one processor to perform operations comprising:
receiving requirements of an organization;
selecting a template comprising recommendations for optimizing a process of the organization based on the requirements; and
outputting the template.

31. The non-transitory computer-readable medium of claim 30, wherein receiving requirements of an organization comprises:
receiving user input defining the requirements from a user in response to a prompt to the user.

32. The non-transitory computer-readable medium of claim 30, wherein the recommendations relate to at least one of utilization of robots, utilization of processes, user activities, or third-party systems.

33. The non-transitory computer-readable medium of claim 30, wherein the process is an RPA (robotic process automation) process.
